(19) United States
(12) Patent Application Publication
(10) Pub. No.: US 2004/0209016 A1
(43) Pub. Date: Oct. 21, 2004

(54) Recording medium excellent in light-resistance and method for production thereof

(76) Inventors: Tadashi Ishida, Sodegaura-shi (JP); Masaya Kusumoto, Sodegaura-shi (JP); Yoshihiko Tomita, Sodegaura-shi (JP); Sota Ito, Sodegaura-shi (JP); Hiroyuki Onishi, Suwa-shi (JP); Masahiro Hanmura, Suwa-shi (JP)

Correspondence Address: BURNS DOANE SWECKER & MATHIS L L P, POST OFFICE BOX 1404, ALEXANDRIA, VA, 22313-1404, US

(21) Appl. No.: 10/484,082

(22) PCT Filed: Jul. 18, 2002
(86) PCT No.: PCT/JP02/07303

(30) Foreign Application Priority Data
Jul. 18, 2001 (JP) 2001-217544

(51) Int. Cl. B41M 5/00

(52) U.S. Cl. 428/32.34

(57) ABSTRACT

An ink jet recording medium comprising a support and, on the support, at least one layer comprising cationic organic particles which have a glass transition temperature of from 70 to 130° C. and comprise (A) 0.1 to 10% by weight of a monomer having a hindered amine type functional group, (B) 0.1 to 10% by weight of a monomer having a benzotriazole type functional group and (C) 80 to 99.8% by weight of a monomer selected from styrene and acrylic monomers.

A process for producing an ink jet recording medium which process comprises applying a suspension of copolymeric particles which have a glass transition temperature of from 70 to 130° C. and comprise (A) 0.1 to 10% by weight of a monomer having a hindered amine type functional group, (B) 0.1 to 10% by weight of a monomer having a benzotriazole type functional group and (C) 80 to 99.8% by weight of a monomer selected from styrene and acrylic monomers, on a support, and allowing the coating surface in a wet state or in a dried state to pressure contact with a mirror roll to smooth the surface.

The present invention can provide the ink jet recording sheet having excellent ink absorption characteristics, color development concentration, water resistance, light resistance, yellowing resistance and surface strength, and the process for producing the recording sheet.

### TECHNICAL FIELD OF THE INVENTION

The present invention relates to an ink-jet recording sheet for use in a printer or plotter utilizing an ink-jet recording method and to a process for producing the recording sheet.

### BACKGROUND OF THE INVENTION

In the ink-jet recording method, recording of images, characters or the like is carried out by adhering ink fine droplets to a recording sheet such as papers, etc with flight by means of various operation principles. The ink-jet recording method has properties such that high-speed operation, low noise operation or multi-color operation can be easily performed, the adaptability to recording patterns is high, development and fixing are unnecessary. Accordingly, it has been rapidly spread as recording devices for various figures including kanji characters, color images and the like in various uses.

Furthermore, owing to the enlargement of the resolution and the color reproduction range, images formed by a multi-color ink-jet method can attain recording which favorably compares with multi-color printing by a photoengraving method and photo-prints by a color photograph method. In the use that the numbers of sheets for preparation is small, the ink-jet recording method has been widely used even in such a field of full color image recording because it can prepare the sheets at a lower cost as compared with a photograph technique.

Additionally, with regard to the printers and plotters utilizing the ink-jet method, the market demands that the image quality should be further improved so that the high resolution and the enlargement of the color reproduction range have been advanced. In the advancement, for example, the maximum ink output volume per paper area unit is increased. Therefore, the increase of the ink receiving volume suitable for the output amount is an important technical subject for the recording sheets and it is essential to ensure the high ink receiving volume or apply with a coating layer having good color development.

In addition to the above properties, the appearance such as glossiness, rigidity, hue etc is desired to approach the same level of silver photographs or printing papers. However, conventional ink-jet recording sheets such as fine finished papers or coating papers cannot sufficiently satisfy these demands.

With increase of the ink-output amount, the ink absorption characteristics are important properties required for the recording sheets so that it is necessary to provide a porous ink-receiving layer having a large amount of voids on a substrate for securing the absorption characteristics.

So, a process of applying a coating composition composed of a large amount of inorganic particles and a small amount of a binder on a substrate and thereby forming an ink-receiving layer has been attempted. In the process, a small amount of the binder is used for bonding the inorganic particles and thereby voids are formed between the inorganic particles to secure the ink absorption characteristics.

In general, an ink liquid used in the ink-jet recording method is prepared by dissolving a water-soluble anionic dye in a solvent essentially composed of water. Therefore, when the printed recording sheet is contacted with water, the dye is released and then the quality of the image is lowered. In order to improve the water resistance, it is necessary to fix the dye on the recording sheet. On this account, a process of ionically fixing the anionic dye by adding a cationic polymer, which is called as a water-resisting agent to the recording sheet, has been widely employed.

The technical development of such a recording sheet method can make the picture quality comparable to photographs, but has a problem in light resistance and yellowing resistance as compared with photographs. With regard to the both problems, in the case of long time preservation, discoloration is remarkably exhibited. Still, the light resistance means a property such that printed images do not discolor, and the yellowing resistance means a property such that the paper surface does not discolor to yellow.

It is considered that these problems are induced with the following reasons. In general, inorganic particulate silica and alumina are preferably used in the ink-receiving layer. However, the inorganic particles have high surface activity so that they catalytically act to accelerate the decomposition of an ink dye and the printed images are discolored, or to accelerate the deterioration of the cationic polymer in the recording paper and the paper surface is discolored to yellow. Further, in the case of giving glossiness to the recording paper surface, because-of using the inorganic particles having a smaller particle diameter, the surface areas of the particles are greatly increased, and the surface activity is enhanced so that these problems are distinctly appeared.

In order to solve these problems, JP-B-8(1996)-13569 discloses a recording material wherein discoloration of a dye is prevented by regulating the pH of a silica type inorganic pigment to 7 or more. It is considered that the active point of the pigment surface catalytically accelerates oxidative decomposition of the dye and further when the pH is 7 or more, the catalyst function is lowered and the pigment becomes inactive.

As another process, there is a process that additives such as an oxidation inhibitor, light stabilizer, ultraviolet light absorber etc are contained in a recording paper. For example, JP-A-3(1991)-13376 discloses a recording material prepared by forming a layer essentially comprised of a pigment on the surface layer of a substrate wherein the layer has a weight ratio of a hindered phenol type compound to a hindered amine type compound of from 1/9 to 7/3. Generally, the hindered phenol type compound is used as an oxidation inhibitor and the hindered amine type compound is used as a light stabilizer. The process for preparing the recording material may include a process of mixing the compound with a coating liquid for the ink receiving layer and applying the mixture, or a process of applying a coating liquid containing the compound on the ink receiving layer. In the ink receiving layer, inorganic pigments such as silica, alumina etc and organic pigments such as urea resins, etc are used so that the compound is contained in the ink receiving layer, except for the pigment used in the ink receiving layer.

General examples of the oxidation inhibitor may include hindered phenol, aromatic amine, organic sulfur and phosphorus compounds. Examples of the light stabilizer and ultraviolet light absorber may include salicylate, benzophenone, benzotriazole, hindered amine, nickel and cyanoacrylate type compounds. These compounds are generally hydrophobic, but the coating agent for forming the ink-receiving layer is generally an aqueous type. Therefore, a process of making the additive into an aqueous emulsified product using a proper dispersing agent and blending the product to the coating agent is frequently adopted. In general, as the emulsified product of the additive contains dispersed particles having a large particle diameter and further has inferior stability, it easily induces disadvantages such that the additive is localized in the ink receiving layer or the emulsion is broken and thereby the additive is partly deposited and separated. Further, when the additive is localized, after long time preservation, the discoloration has a partial difference to make shading, or when the additive is partly deposited, unevenness of printing occurs by ink cissing. On this account, there are further problems such that it is difficult to use a large amount of the additive, or the dispersing agent used has a bad influence upon the print quality.

For the problems, JP-A-2000-177241 discloses an ink jet recording sheet prepared by adding an oxidation inhibitor to a substrate paper. In the publication, it is described that the substrate paper is impregnation-treated in a solution or dispersing solution of the oxidation inhibitor to form an ink-receiving layer on the substrate paper in order to prevent localization of the oxidation inhibitor or partial deposition or separation of the oxidation inhibitor caused by adding the oxidation inhibitor to the ink-receiving layer. The process, however, still has an insufficient effect because the oxidation inhibitor is absent in the ink-receiving layer in which ink dyes are present in the most amounts.

As described above, it is at present difficult for the present techniques to prepare an ink jet recording sheet having excellent light resistance and yellowing resistance with keeping ink absorption characteristics, color development concentration and water resistance.

### OBJECT OF THE INVENTION

The present invention is intended to solve the above various problems and it is an object of the invention to provide an ink jet recording sheet having excellent light resistance and yellowing resistance with keeping ink absorption characteristics, color development concentration and water resistance. It is a further object of the invention to provide a process for producing the recording sheet.

### SUMMARY OF THE INVENTION

The present inventors have earnestly studied for solving the problems associated with the prior arts and found that a part or all of inorganic particles used in the conventional techniques are replaced with cationic organic particles having a specific composition and thereby an ink jet recording sheet having not only excellent ink absorption characteristics, color development concentration and water resistance, but also excellent light resistance and yellowing resistance can be prepared. Thus, the present invention has been accomplished.

The specific cationic organic particles used in the present invention are slightly fusion bonded each other on the surfaces thereof so that they can have both the particle voids and the surface strength, and thereby can form the voids same as those formed by inorganic particles used in the conventional techniques. Accordingly, the sheet containing only the organic particles and free from the inorganic particle can have excellent ink absorption characteristics. Because the cationic organic particles themselves have a functional group capable of improving the light resistance, the cationic organic particles do not induce localization or deposition on sheets which are induced in the case of adding an additive such as an oxidation inhibitor, light stabilizer etc. On this account, the cationic organic particles are applicable to an ink absorbing layer and using the cationic organic particles can prepare a sheet which has excellent light resistance and yellowing resistance without producing unevenness of printing and color shading caused by long time preservation. Further, the organic particles are cationic and have themselves a function of fixing an anionic ink dye so that a sheet containing the cationic organic particles has excellent color development concentration and water resistance.

That is, the present invention provides an ink jet recording medium comprising a support and, on the support, at least one layer comprising the cationic organic particles which have a glass transition temperature of from 70 to 130° C. and are copolymer particles comprising:

(A) 0.1 to 10% by weight of a monomer having a hindered amine type functional group,

(B) 0.1 to 10% by weight of a benzotriazole type functional group and

(C) 80 to 99.8% by weight of a monomer selected from styrene and acrylic monomers.

The cationic organic particles preferably have an average particle diameter of from 10 to 500 nm, a particle diameter distribution such that the ratio of weight average particle diameter Dw to number average particle diameter Dn (Dw/Dn) is from 1.0 to 2.0. Furthermore, the cationic organic particles preferably have a weight average molecular weight of not less than 10000.

In the copolymer, the monomer having a hindered amine type functional group (A) is preferably selected from 1,2,2,6,6-pentamethyl-4-piperidyl methacrylate, 2,2,6,6-tetramethyl-4-piperidyl methacrylate, 1,2,2,6,6-pentamethyl-4-piperidyl acrylate and 2,2,6,6-tetramethyl-4-piperidyl acrylate.

Further, in the copolymer, the benzotriazole type functional group having monomer (B) is preferably 2-(2′-hydroxy-5′-methacryloyl oxy ethyl phenyl)2H-benzotriazole.

The suitable copolymer particles are preferably prepared by copolymerizing the monomers (A), (B) and (C) using an initiator containing an amidino group.

It is preferred that the layer comprising the cationic organic particles be free from inorganic particles.

In the ink jet recording medium according to the present invention, the support-is preferably made of a paper or a plastic sheet.

The ink jet recording medium according to the present invention can be preferably prepared by the steps of applying a suspension of copolymer particles which have a glass transition temperature of from 70 to 130° C. and comprise (A) 0.1 to 10% by weight of a monomer having a hindered. amine type functional group, (B) 0.1 to 10% by weight of a benzotriazole type functional group and (C) 80 to 99.8% by weight of a monomer selected from styrene and acrylic monomers, on a support, and allowing the coated surface in a wet state or in a dried state to pressure contact with a mirror roll to smooth the surface.

### BEST MODE OF EMBODIMENT FOR CARRYING OUT THE INVENTION

The ink jet recording medium of the present invention comprises a support and, on the support, at least one layer comprising cationic organic particles as an ink receiving layer. The cationic organic particles have a glass transition temperature of from 70 to 130° C. and comprise (A) 0.1 to 10% by weight of a monomer having a hindered amine type functional group, (B) 0.1 to 10% by weight of a monomer having a benzotriazole type functional group and (C) 80 to 99.8% by weight of a monomer selected from styrene and acrylic monomers.

The present invention will be described in detail hereinafter.

[(A) Monomer Having a Hindered Amine Type Functional Group]

The hindered amine type functional group used in the present invention is a functional group contained in a hindered amine type light stabilizer which is generally abbreviated to HALS, and examples thereof may include functional groups having a 2,2,6,6-tetra-alkyl piperidine skeleton such as 2,2,6,6-tetramethyl piperidyl, 1,2,2,6,6-pentamethyl piperidyl, 1-ethyl-2,2,6,6-tetramethyl piperidyl, 1-butyl-2,2,6,6-tetramethyl piperidyl, 2,6-dimethyl-2,6-diethyl piperidyl, 1,2,6-trimethyl-2,6-diethyl piperidyl, 1-butyl-2,6-dimethyl-2,6-diethyl piperydyl etc. Of these, preferable examples of the hindered amine type functional group are 2,2,6,6-tetramethyl piperidyl and 1,2,2,6,6-pentamethyl piperidyl.

The theory of the mechanism that these hindered amine type functional groups have an effect on the light resistance and-the yellowing resistance is not established, but as described in “Polyer light deterioration and stabilization” Chapter 5 (written by Osawa Zenjiro published by CMC Co. Ltd.), it is presumed that they scavenge an active radical species generated in the dye or polymer deterioration step. Further, hindered phenol has the same improving effect of light resistance as the hindered amine type functional groups by the same function, but occasionally induces yellowing with the passage of time. Therefore, the hindered amine is more preferred. The combined use of the hindered amine type functional group and the benzotriazole functional group can prepare a sheet having more excellent light resistance and yellowing resistance.

Examples of the monomer having the hindered amine type functional group (A) may include 1,2,2,6,6-pentamethyl-4-piperidyl methacrylate, 2,2,6,6-tetramethyl-4-piperidyl methacrylate, 1,2,2,6,6-pentamethyl-4-piperidyl acrylate and 2,2,6,6-tetramethyl-4-piperidyl acrylate, and further compounds having an unsaturated bond as disclosed in the publications in JP-B-2(1991)-1140, JP-A-63(1988)-267758, JP-A-2(1991)-49763 and JP-A-2(1991)-281009.

Particularly, 1,2,2,6,6-pentamethyl-4-piperidyl methacrylate, 2,2,6, 6-tetramethyl-4-piperidyl methacrylate, 1,2,2,6,6-pentamethyl-4-piperidyl acrylate and 2,2,6,6-tetramethyl-4-piperidyl acrylate are preferable because the polymer constituting the cationic organic particles is easily produced.

[Monomer Having a Benzotriazole Type Functional Group (B)]

The benzotriazole type functional group used in the present invention is a functional group capable of absorbing ultraviolet light and for example, may include 2-(2′-hydroxy-5′-methylphenyl)benzotriazole, 2-(2′-hydroxy-5′-t-butylphenyl)benzotriazole, 2-(2′-hydroxy-5′-t-octylphenyl)benzotriazole, 2-(2′-hydroxy-3′-t-butyl-5′-methylphenyl)-5-chlorobenzotr iazole, 2-(2′-hydroxy-5′-3′,5′-di-t-butylphenyl)benzotriazole, 2-(2′-hydroxy-3′-t-butyl-5′-methylphenyl)-5-chlorobenzotriazole, 2-(2′-hydroxy-5′-methacryl oxy ethyl phenyl-2H-benzotriazole, 2-(2′-hydroxy-5′-acryl oxy ethyl phenyl-2H-benzotriazole etc.

Examples of the benzotriazole type functional group having monomer (B) include 2-(2′-hydroxy-5′-methacryl oxy ethyl phenyl)-2H-benzotriazole, 2-(2′-hydroxy-5′-methacryl oxy phenyl)-benzotriazole, 2-hydroxy-4-(2-methacryl oxy)ethoxy benzophenone, 2-(2′-hydroxy-5′-methacryl oxy phenyl)-5-chloro benzotriazole etc. Particularly, 2-(2′-hydroxy-5′-methacryloyl oxy ethyl phenyl)-2H-benzotriazole is more preferred because the polymer constituting the cationic organic particles is easily produced.

[(C) Acrylic Monomer]

The component (C), which is a main monomer of the above copolymer, is selected from styrene and acrylic monomers. The acrylic monomers may include an acrylic acid, methacrylic acid and their derivatives, such as-ester, amide, nitrile, acid anhydride, acid hydride etc. Specific examples of the acrylic monomer may include:

acrylic acid esters, e.g. 1 to 12 C alkyl ester of an acrylic acid such as methyl acrylate, ethyl acrylate, isopropyl acrylate, N-butyl acrylate, isobutyl acrylate, N-amyl acrylate, iso-amyl acrylate, N-hexyl acrylate, 2-ethyl hexyl acrylate, octyl acrylate, decyl acrylate, dodecyl acrylate, octadecyl acrylate, cyclohexyl acrylate, phenyl acrylate and benzyl acrylate;

methacrylic acid esters, e.g. 1 to 12C alkyl ester of a methacrylic acid such as methyl methacrylate, ethyl methacrylate, isopropyl methacrylate, N-butyl methacrylate, isobutyl methacrylate, N-amyl methacrylate, isoamyl methacrylate, N-hexyl methacrylate, 2-ethylhexyl methacrylate, octyl methacrylate, decyl methacrylate, dodecyl methacrylate, octadecyl methacrylate, cyclohexyl methacrylate, phenyl methacrylate and benzyl methacrylate;

hydroxyl group-containing methacrylic acid esters such as 2-hydroxyethyl acrylate, hydroxyl propyl acrylate, 4-hydroxybutyl acrylate, 2-hydroxyethyl methacrylate, hydroxypropyl methacrylate and 4-hydroxybutyl methacrylate;

aminoalkyl acrylates or aminoalkyl methacrylates, or their quaternary salt of methyl halide, ethyl halide or benzyl halide etc such as N,N-dimethyl aminoethyl acrylate, N,N-dimethyl aminoethyl methacrylate, N,N-dimethyl aminopropyl acrylate, N,N-dimethyl aminopropyl methacrylate, N,N-t-butyl aminoethyl acrylate, N,N-t-butyl aminoethyl methacrylate, N,N-mono-methyl aminoethyl acrylate, N,N-mono-methyl aminoethyl methacrylate or their quaternary salt of methyl halide, ethyl halide, benzyl halide etc;

(meth) acryl amides such as acryl amide, methacryl amide, N-isopropylacrylamide, N,N-dimethyl acrylamide, N,N-dimethyl methacrylamide, N,N-diethylacryl amide, N,N-diethyl methacryl amide, N-methyrol methacryl amide, N-methyrol acryl amide or-diacetone acryl amide;

N-aminoalkylacryl amides or N-aminoalkyl methacrylamides, or their quaternary salt of methyl halide, ethyl halide or benzyl halide, such as N,N-dimethyl aminopropyl acryl amide, N,N-dimethyl aminopropyl methacrylamide, N,N-dimethyl aminoethyl acrylamide, N,N-dimethyl aminoethyl methacrylamide, or their quaternary chlorides of methyl halide, ethyl halide or benzyl halide;

carboxylic acids, their anhydrides and nitriles, e.g. acrylic acid, methacrylic acid, anhydrous acrylic acid, anhydrous methacrylic acid, acrylonitrile, methacrylonitrile, diacrylates such as polyethylene glycol diacrylate, 1,6-hexanediol diacrylate, neopentyl glycol diacrylate, tripropylene glycol diacrylate or polypropylene glycol diacrylate;

dimethacrylates such as ethylene glycol dimethacrylate, diethylene glycol dimethacrylate, triethylene glycol dimethacrylate, polyethylene glycol dimethacrylate, polypropylene glycol dimethacrylate, neopentylglycol dimethacrylate, 1,3-butylene glycol dimethacrylate, 1,6-hexane diol dimethacrylate or neopentyl glycol dimethacrylate; and

other (meth)acrylic acid esters such as trimethylol propane trimethacrylate, trimethylol propane triacrylate, tetramethyol methane triacrylate, tetramethyol methane tetra-acrylate, allyl methacrylate, dicyclopentenyl acrylate, dicyclopentenyl oxy ethyl acrylate, 2-methoxy ethylacrylate, 2-ethoxy ethyl acrylate, glycidyl acrylate or glycidyl methacrylate.

Preferable examples of the acrylic monomers are methyl acrylate, ethyl arylate, N-butyl acrylate, isobutyl acrylate, 2-ethyl hexyl acrylate, methyl methacrylate, N-butyl methacrylate, isobutyl methacrylate, ethyl methacrylate, and 2-ethyl hexyl methacrylate.

It is preferred to use functional groups capable of exerting strong interaction with a dye, for example, a monomer having a functional group with hydrogen bonding ability because they have excellent light resistance. Examples thereof are monomers having a carboxylic acid group, hydroxyl group, aromatic ring or amide group. More preferable examples of the monomers having excellent yellowing resistance are carboxylic acids, hydroxyl group-containing (meth)acrylic acid esters and amides.

The cationic organic particles used in the present invention are copolymer particles obtainable by copolymerizing (A) the hindered amine type functional group having monomer, (B) the benzotriazole type functional group having monomer and (C) the monomer selected from styrene and acrylic monomers. The proportion of the monomers comprises., on the basis of the total weight, 0.1 to 10% by weight of the monomer (A), 0.1 to 10% by weight of the monomer (B) and 80 to 99.8% by weight of the monomer (C), preferably 1 to 5% by weight of the monomer (A), 1 to 5% by weight of the monomer (B) and 90 to 98% by weight of the monomer (C), more preferably 1 to 3% by weight of the monomer (A), 1 to 3% by weight of the monomer (B) and 94 to 98% by weight of the monomer (C). Herein, one kind or two or more kinds of the monomers can be used as each of the monomers (A), (B) and (C).

When the amount of the monomer (A) or (B) is over 10% by weight, the yellowing resistance of the resulting medium is occasionally lowered. When the amount of the monomer (A) or (B) is less than 0.1% by weight, the resulting medium occasionally cannot exhibit the sufficient effect on the light resistance and the yellowing resistance.

In the copolymer of the monomers (A), (B) and (C), small amounts of other monomers may be copolymerized. Examples of the other monomers may include vinyl esters such as vinyl acetate, vinyl propionate etc, unsaturated carboxylic acids or derivatives thereof, such as maleic acid, itaconic acid, fumaric acid, maleic anhydride, itaconic anhydride, fumaric anhydride or maleic acid amide, allylglycidyl ether, isopropenyl-α,α-dimethyl benzyl isocyanate, allylmercaptane etc.

[Glass Transition Temperature (Tg) of Cationic Organic Particles]

The cationic organic particles of the present invention have a glass transition temperature of from 70 to 130° C., preferably 70 to 120° C. When the glass transition temperature is less than 70° C., the cationic organic particles are markedly deformed so that the voids between the fine particles are occasionally decreased to lower the ink absorption characteristics of the resulting medium. When the glass transition temperature of the cationic organic particles is over 130° C., the surface smoothness of the resulting medium is lowered to decrease the glossiness. The glass transition temperature in the present specification is determined from a DSC curve on the basis of JIS K7121.

[Particle Diameter of Cationic Organic Particle]

The cationic organic particles of the present invention have a weight average particle diameter or number average particle diameter of preferably from 10 nm to 500 nm, more preferably 10 nm to 300 nm, most preferably 10 nm to 150 nm. When the average particle diameter is less than 10 nm, the voids between the particles are insufficient and the ink absorption characteristics of the resulting medium are insufficient to lower the dryness or the picture quality occasionally. When the average particle diameter is more than 500 nm, the transparency of the layer containing the cationic organic particles is lowered and thereby the visibility of the dye inside the layer or under the layer is lowered to invite the lowering of the color development concentration occasionally.

Further, the particle diameter distribution is a factor, which influences the ink absorption characteristics. The particle diameter distribution can be represented by a ratio (Dw/Dn) of a weight average particle diameter Dw to a number average particle diameter Dn. The cationic organic particles of the present invention have a ratio Dw/Dn, as a particle diameter distribution, of preferably from 1.0 to 2.0, more preferably 1.0 to 1.5, further more preferably 1.0 to 1.3. When all the particles have the same particle diameter, the ratio Dw/Dn is 1.0 and the ratio of not less than 1.0 is impossible. When the ratio Dw/Dn is over 2.0, the large particles and the small particles are mixed markedly, and the small particles enter the spaces between the large particles so that the voids between particles are insufficient to invite insufficiency in the ink absorption characteristics of the resulting medium occasionally.

The particle diameter is determined by observation with an electron microscope or a light scattering method. For example, in the light scattering method, the measurement is carried out by laser particle diameter analysis system LPA-3000/3100 (Otsuka electron Co. Ltd.), laser diffraction particle distribution measurement apparatus SALD-2000A (Shimazu Seisakusho Co. Ltd.) etc.

[Molecular Weight of Cationic Organic Particles]

The cationic organic particles of the present invention have a weight average molecular weight of preferably not less than 10000, more preferably 60,000 to 2,000,000, further preferably 100,000 to 2,000,000. When the cationic organic particles have a weight average molecular weight of less than 10000, they are easily deformed and the voids between the particles are decreased to lower the ink absorption characteristics of the resulting medium occasionally.

[Process for Producing the Cationic Organic Particles]

The cationic organic particles used in the present invention can be produced directly by a known emulsification polymerization method, or by finely dispersing a copolymer prepared by another polymerization method in a liquid medium with a mechanical emulsification method. Examples of the emulsification polymerization method may include a method of charging the various monomers all together in the presence of a dispersing agent and an initiator, and a method of conducting polymerization with continuously feeding the monomers. The polymerization is carried out at a temperature of usually from 30 to 90° C. and an aqueous dispersion of the cationic organic particles which are generally called as an emulsion is substantially obtained. The aqueous dispersion of the cationic organic particles prepared by the emulsion polymerization method with a small amount of the dispersing agent is very stable and can prepare particles having a very small particle diameter so that the aqueous dispersion is excellent.

The dispersing agent preferably used herein may include cationic surface active agents, nonionic surface active agents, cationic water soluble polymers, nonionic water soluble polymers etc, and these dispersing agents may be used singly or in combination with two or more.

Examples of the cationic surface active agents are lauryl trimethyl ammonium chloride, stearyl trimethyl ammonium chloride, cetyl trimethyl ammonium chloride, distearyl dimethyl ammonium chloride, alkylbenzyl dimethyl ammonium chloride, lauryl betaine, stearyl betaine, lauryl dimethyl amine oxide, laury carboxymethyl hydroxyethyl imidazolinium betaine, coconut amine acetate, steary amine acetate, alkyl amine guanidine polyoxy ethanol, alkylpicolinium chloride etc. These may be used singly or in combination with two or more.

Examples of the nonionic surface-active agents may include polyoxy ethylene lauryl ether, polyoxy ethylene octyl phenyl ether, polyoxy ethylene oleyl phenyl ether, polyoxy ethylene nonyl phenyl ether, oxyethylene/oxypropylene block copolymer, t-octyl phenoxy ethyl polyethoxy ethanol, nonyl phenoxy ethyl polyethoxy ethanol etc. These may be used singly or in combination with two or more.

Examples of the cationic water soluble polymers may include cationized polyvinyl alcohol, cationized starch, cationized polyacrylamide, cationized polymethacryl amide, polyamide polyurea, polyethylene imine, allylamine or its salt and copolymer thereof, epichlorohydrin-dialkyl amine adduct polymer, diallyl alkyl amine or its salt and polymer thereof, diallyl dialkyl ammonium salt polymer, copolymer of diallylamine or its slat with sulfur dioxide, diallyldialkyl ammonium salt-sulfur dioxide copolymer, copolymer of diallyl dialkyl ammonium salt with diallyl amine or its salt or derivative, diallyl dialkyl ammonium salt-acrylamide copolymer, amine-carboxylic acid copolymer, dialkyl amino ethyl(meth)acrylate copolymer. These may be used singly or in combination with two or more.

Examples of the dialkyl aminoethyl(meth)acrylate polymers may include aminoalkyl acrylates or aminoalkyl methacrylates such as N,N-dimethylamino ethyl acrylate, N,N-dimethylamino ethylmethacrylate, N,N-dimethylamino propyl acrylate, N,N-dimethylaminopropyl methacrylate, N,N-t-butylaminoethyl acrylate, N,N-t-butylamino ethyl methacryalte, N,N-monomethyl aminoethyl acrylate, N,N-monomethyl aminoethylmethacrylate etc;

N-aminoalkyl acryl amides or N-aminoalkyl methacryl amides such as N,N-dimethyl acrylamide, N,N-dimethyl methacrylamide, N,N-diethyl acrylamide, N,N-diethyl methacrylamide, N,N-dimethyl aminopropylacrylamide, N,N-dimethyl aminopropylmethacrylamide, N,N-dimethyl aminoethylacrylamide, N,N-dimethyl aminoethylmethacrylamide, N-isopropyl acrylamide etc; and/or their methyl halide, ethyl halide or benzyl halide tetra chlorinated homopolymers or copolymers.

Examples of the nonionic water soluble polymers may include polyvinyl alcohol or its derivatives; starch derivatives such as oxidized starch, etherificated starch, starch phosphate etc; polyvinylpyrolidone or polyvinyl pyrolidone derivatives obtainable by copolymerizing a vinyl acetate; cellulose derivatives such as carboxymethyl cellulose, hydroxymethyl cellulose etc; polyacryl amide or its derivatives; polyacrylamide or its derivatives; gelatin, casein etc. Of these, one kind or two or more kinds may be selected.

The dispersing agent may be used without limitation of the amount, and usually in an amount of from 0.02 to 20% by weight, more preferably 0.02 to 10% by weight, most preferably 0.02 to 5% by weight based on the total amount of the monomers for copolymerization.

The initiator used in the copolymerization may include usual radical initiators, for example, hydrogen peroxide; persulfates such as ammonium persulfate, potassium persulfate etc; organic peroxides such as cumene hydroperoxide, t-butyl hydroperoxide, benzoyl peroxide, t-butyl peroxy-2-ethyl hexanoate, t-butylperoxy benzoate, lauroyl peroxide etc;

azo compounds such as azobisisobutylo nitrile,

2,2′-azobis(2-amidinopropane)dihydrochloride,

2,2′-azobis[2-(N-phenylamidino)propane]dihydrochloride,

2,2′-azobis{2-[N-(4-chlorophenyl)amidino]propane}dihydrochloride,

2,2′-azobis{2-{N-(4-hydroxyphenyl)amidino}propane}dihydrochloride,

2,2′-azobis[2-(N-benzylamidino)propane]dihydrochloride,

2,2′-azobis[2-(N-allylamidino)propane]dihydrochloride,

2,2′-azobis{2-[N-(2-hydroxyethyl)amidino]propane}dihydrochloride,

2,2′-azobis{2-methyl-N-{1,1-bis(hydroxymethyl)-2-hydroxy ethyl}propion amide},

2,2′-azobis{2-methyl-N-[1,1-bis(hydroxymethyl) ethyl]propion amide},

2,2′-azobis[2-methyl-N-(2-hydroxyethyl)propion amide,

2,2′-azobis(isobutylamide)dehydrate etc; and redox initiators prepared by the combined use of the above compounds, metal ions such as ferrous ion, etc and a reducing agent such as sodium sulfoxylate, formaldehyde, pyrosodium sulfite, sodium bisulfite, L-ascorbic acid, Rongalite etc. Of these, one kind or two or more kinds may be selected.

The initiators used for obtaining the cationic organic particles are preferably initiators containing an amidino group, for example,

2,2′-azobis(2-amidinopropane)dihydrochloride,

2,2′-azobis[2-(N-phenylamidino)propane]dihydrochloride,

2,2′-azobis[2-(N-(4-chlorophenyl)amidino)propane]dihydrochloride,

2,2′-azobis[2-(N-hydroxyphenyl)amidino]propane]dihydrochloride,

2,2′-azobis[2-(N-benzylamidino)propane]dihydrochloride,

2,2′-azobis[2-(N-allylamidino)propane]dihydrochloride and

2,2′-azobisf2-[N-(2-hydroxyethyl)amidino]propane}dihydrochloride, and further preferably

2,2′-azobis(2-amidinopropane)dihydrochloride.

The use of the initiator containing an amidino group can further improve the light resistance and yellowing resistance of the resulting medium.

In the case of polymerizing the copolymer, the initiator is used in an amount of from 0.01% by weight to 20% by weight, preferably 0.1% by weight to 10% by weight, more preferably 0.2% by weight to 5% by weight based on all the monomers constituting the copolymer. When the amount is less than 0.01% by weight, the polymerization is not sometimes completed. When the amount is more than 20% by. weight, the molecular weight of the copolymer lowers so that the ink absorption characteristics and water resistance of the resulting medium are occasionally lowered.

Further, if necessary, it is possible to use, as a molecular weight modifier, mercaptans such as t-dodecyl mercaptan, N-dodecyl mercaptan etc, and allyl compounds such as allyl sulfonic acid, methallyl sulfonic acid and their sodium salts.

Additionally, if necessary, it is possible to use, as a pH modifier, sulfuric acid, hydrochloric acid, nitric acid, sodium hydrate, potassium hydroxide, magnesium sulfate, potassium sulfate, aluminum sulfate, sodium acetate, magnesium acetate, potassium acetate, ammonia, triethanol amine, diethanol amine, monoethanol amine etc. Particularly, it is preferred to use the metal salts or amines having cationic properties in water in the point of improving the water resistance and light resistance of the resulting recording sheet.

[Layer Formed From the Cationic Organic Particles]

The inkjet recording mediums of the present invention have at least one ink-receiving layer formed from the cationic organic particles as described. The layer may be formed from only the organic particles or may be formed from the organic particles and other components such as a binder, inorganic particles etc.

The layer formed from the cationic organic particles according to the present invention contains the cationic organic particles in an amount of from 20 to 100% by weight, more preferably 50 to 100% by weight, further preferably 70 to 100% by weight. When the amount is less than 20% by weight, solidification of the ink dye is insufficient and thereby the color development concentration and water resistance of the layer occasionally lower.

The specific cationic organic particles used in the present invention can form the same voids as those of conventional inorganic particles. In the case of the inorganic particles, a binder is necessary for bonding the particles each other in order to keep the surface strength. The binder fills up the voids between the particles to lower the void proportion and thereby the ink absorption characteristics of the layer is decreased. Contrarily, different from the inorganic particles, the cationic organic particles of the present invention are slightly fusion bonded each other on the surfaces and thereby the particle voids and the surface strength can be kept simultaneously. Therefore, even if the layer comprises only the cationic organic particles, that is, the cationic organic particle containing layer contains 100% by weight of the cationic organic particles (free from the inorganic particles and the binder), the excellent ink absorption characteristics and surface strength can be kept. Further, in the case of improving the surface strength, the effect can be attained using a small amount of the binder so that the cationic organic particles have a property largely different from the inorganic particles.

In the case of preparing the recording sheet endowed with glossiness by using the cationic organic particles according to the present invention, parts of the cationic organic particles present on the surface are deformed to improve the smoothness of the surface. Therefore, even if the recording sheet has such a structure of a single layer or less layers than the conventional structures, the recording sheet can have both ink absorption characteristics and glossiness without forming the conventional multi-layered structure such that a glossiness-imparting layer is applied on the ink-absorbing layer. Accordingly, the layer formed from the cationic organic particles according to the present invention also has excellent property in production enhancement.

[Components for Mixing]

To the layer formed from the cationic organic particles of the present invention, various additives can be blended. For example, a polymer having a binder function can be added to improve the surface strength or glossiness. The polymer having a binder function may include a water-soluble polymer or an aqueous dispersion of a water-insoluble polymer. The detail will be described below.

The water soluble polymers are, for example, the cationic water soluble polymers such as cationized polyvinyl alcohol, cationized starch, cationized polyacryl amide, cationized polymethacryl amide, polyamide polyurea, polyethylene imine, allyl amine or its salt copolymer, epichlorohyrin-dialkyl amine adduct polymer, diallylalkyl amine or its salt polymer, diallyl dialkyl ammonium salt polymer, diallyl amine or it salt and sulfur dioxide copolymer, diallyl dialkyl ammonium salt-sulfur dioxide copolymer, diallyldialkyl ammonium salt and diallyl amine or its salt or derivative copolymer, dialkylaminoethyl acrylate quaternary salt polymer, dialkyl aminoethyl methacrylate quaternary salt polymer, diallyldialkyl ammonium salt-acrylamide copolymer, amine-carboxylic acid copolymer etc.

Further, examples of the nonionic water soluble polymers are polyvinyl alcohol or its derivatives; starch derivative such as oxidized starch, etherisified starch, phosphated starch; polyvinyl pyrolidone or polyvinyl pyrrolidone derivatives such as polyvinyl pyrrolidone prepared by copolymerizing vinyl acetate; its cellulose derivatives such as carboxymethyl cellulose, hydroxymethyl cellulose etc; polyacrylamide or its derivatives; polymethacrylamide or its derivatives; gelatin, casein etc.

The water dispersions of the water insoluble polymers may include water dispersions of acrylic polymers (acrylate and/or methacrylate polymers or copolymers), styrene-acrylic polymer (styrene and acrylate and/or methacrylate copolymers), MBR polymers (methylmethacrylate-butadiene copolymers), SBR polymers (styrene-butadiene copolymers), urethane polymers, epoxy polymers, EVA polymers (ethylene-vinyl acetate copolymers).

Particularly because of having excellent yellowing resistance, the water dispersions of polyvinyl alcohol, cationized polyvinyl alcohol, acryl polymers (acrylate and/or methacrylate polymers or copolymers) are preferred. Further, in the water dispersions, the polymer desirably has a glass transition temperature of lower than 40° C.

The polymers having a binder function are used in an amount of preferably 0 to 20 parts by weight, more preferably 0 to 10 parts by weight, further preferably 0 to 5 parts by weight based on 100 parts by weight of the cationic organic particles or, if the inorganic particles are contained, 100 parts by weight of the cationic organic particles and the inorganic particles.

When the binder amount is large, the voids between the particles are filled with the binder so that the ink absorption characteristics are occasionally lowered.

The layer formed from the cationic organic particles of the present invention has excellent ink absorption characteristics even if it dose not substantially contain inorganic particles such as silica, alumina etc. Therefore, it is preferred that the layer does not contain the inorganic particles. If it contains the inorganic particles, the light resistance and yellowing resistance thereof are occasionally lowered.

The cationic organic particle-containing layer of the present invention may contain an antistatic agent, antioxidant, dried paper strength reinforcing agent, wet paper strength reinforcing agent, water proofing agent, antiseptic agent, ultraviolet absorbing agent, light stabilizer, fluorescent whitening agent, coloring pigment, coloring dye, introfier, foaming agent, releasing agent, deforaming agent, anti-foaming agent, fluidity improver, thickening agent, pigment dispersing agent, cationic bonding agent and the like.

[Constitution of Recording Medium]

In the preferable composition of the recording medium of the present invention, the cationic organic particle-containing layer is used for the layer relating with ink receiving. For example, there are a single layer structure in which the cationic organic particle-containing layer of the present invention is only provided on a support, and multi layer structures in which an ink-receiving layer is provided on a substrate, the cationic organic particle-containing layer of the present invention is provided thereon, and further other layer is optionally provided thereon.

The layer formed from the cationic organic particles of the present invention is generally formed in an amount of 1 to 300 g/m² on the support, but the amount is not particularly limited.

[Support]

In the present invention, examples of the support may include supports generally used for ink jet recording mediums, for example, paper supports such as plain paper, art paper, coat paper, cast coat paper, resin-coated paper, resin-immersed paper, non-coating paper, coating paper etc, paper supports having both surfaces or one surface coated with polyolefin such as polyethylene and/or polyethylene kneaded with a white pigment of titanium, etc, plastic support, non-woven fabric cloth, cloth, woven fabrics, metal films, metal plates and composite supports laminated with these substrates.

As the plastic supports, it is preferred to use plastic sheets or films such as polyethylene, polypropylene, polystyrene, polyethylene terephthalate, polyethylene naphthalate, triacetyl cellulose, polyvinyl chloride, polyvinylidene chloride, polyimide, polycarbonate, cellophane, polynylon etc. These plastic supports are classified into transparent, semi-transparent and opaque supports and they can be used each in its proper use.

Further, it is also preferred to use a white plastic film as a support. Examples of the white plastic support may include supports prepared by adding a small amount of a white pigment such as barium sulfide, titanium oxide, zinc oxide etc into a plastic, a foamed plastic support prepared by providing a plurality of fine voids to give opaqueness and supports provided with a white pigment (titanium oxide or barium sulfite) containing layer.

In the present invention, the-shapes of the supports are limited. Usually, it is possible as the supports to use film, sheet or plate shape and further cylindrical shape for beverage cans, disk shape for CD, CD-R etc and other complicated shapes.

[Process for Producing Recording Medium]

The process for producing the recording medium with a sheet support according to the present invention will be described. Firstly a coating solution containing the cationic organic particles is applied on one surface or the both surfaces of the sheet support, drying them and thereby forming a layer. The coating solution is generally prepared by dispersing organic particles obtainable by emulsification polymerization and optionally other mixable components in water. The coating solution preferably has a solid concentration of about from 5 to 60% by weight.

The method of applying the coating solution is not limited, for example, it is possible to employ conventionally known coating methods, such as air knife coater, roll coater, bar coater, blade coater, slide hopper coater, gravuer coater, flexo gravuer coater, curtain coater, extrusion coater, floating knife coater, commer coater, die coater etc. The coating solution is applied and then successively the coated surface is dried.

In the case of giving glossiness, the processing method thereof is also particularly limited. For example, the coating solution is applied and thereafter the wet or dried coated surface is allowed to pressure contact with a mirror roll to smooth the coated surface by a general calendar processing method or cast coating method. In the calendar processing method, it is possible to employ a conventionally known method that using a calendaring equipment such as super calendar, gloss calendar etc, the coated surface is smoothed by passing between rolls with application of pressure and temperature.

In the cast coating method, it is possible to employ a direct method, solidification method, re-wet method, pre-cast method etc which are generally carried out in the production of printing cast coat papers. That is, the cast coating method is carried out in such a way that a coated layer on a substrate is brought into in a wet state, the wet layer is allowed to pressure contact with a heated mirror roll and the mirror surface of the roll is transferred to give glossiness, and the layer is dried during it is contacted with the roll.

The direct method is carried out in such a way that a coated layer in an un-dried state is allowed to pressure contact with a heated mirror roll. The re-wet method is carried out in such a way that a coated layer is dried, and thereafter the layer is again wetted in a liquid essentially containing water and allowed to pressure contact with a heated mirror roll to dry the layer.

In the calendaring processing method or cast coating method, the pressure in the pressure contacting with the mirror roll, the temperature of the mirror roll and the coating rate are appropriately selected. Particularly, the temperature of the mirror roll is preferably lower than the glass transition temperature of the cationic organic particles. When the temperature of the mirror roll is higher than the glass transition temperature of the cationic organic particles, particles are deformed greatly, and the voids between the particles are decreased so that the ink absorption characteristics of the layer is occasionally lowered.

### EFFECT OF THE INVENTION

The present invention can provide ink jet recording sheets having excellent ink absorption characteristics, color development concentration, water resistance, light resistance, yellowing resistance and surface strength, and provides a process for producing the recording sheets.

### EXAMPLE

The present invention is described with reference to as the following non-limiting examples in below. In the examples, the units “part” and “%” indicate part by weight and % by weight unless otherwise specified.

### Example 1

<Preparation of Cationic Organic Particles>

In Example 1, 195.9 parts of de-ionized water and 0.1 part of stearyl trimethyl ammonium chloride were fed to a reactor and heated to 70° C. in a nitrogen stream, and then 2 parts of 2,2′-azobis (2-amidinopropan)dichlorinate. Separately from the reactor, 81.0 parts of methyl methacrylate, 10.0 parts of N-butyl acrylate, 5.0 parts of 2-hydroxyethyl methacrylate, 2.0 parts of 2-(2′-hydroxy-5′-methacryloxyethylphenyl)-2H-benzotriazole and 2.0 parts of 2,2,6,6-tetramethyl-4-pyperidyl methacrylate were emulsified in 40.0 parts of de-ionized water using 0.3 part of strearyl trimethyl ammonium chloride to prepare an emulsified mixture, and then the emulsified mixture was dropped to the reactor over 4 hr, and kept at the same temperature for 4 hr.

In result, an emulsion composition in which the cationic organic particles are dispersed in water was prepared and had an un-volatile content of 30%, a pH of 6, an average particle diameter, as determined by light scattering measurement, of 98 nm, a particle diameter distribution Dw/Dn of 1.10 and a glass transition temperature as determined from a DSC curve based on JIS K 7121 of 86° C.

<Preparation of Recording Sheet>

On a fine finished paper having a weighing of 105 g/m², the emulsion composition in which the cationic organic particles were dispersed in water was applied in an amount such that the absolutely dried coating amount was 20 g/m², and then dried at 50° C. for 100 sec. Subsequently, the recording sheet was passed through a mirror roll which surface was kept at 75° C. while pressure contacting at a linear pressure of 100 Kg/cm. In result, a recording sheet of Example 1 was prepared and had a gloss of 80.

### Example 2

<Preparation of Cationic Organic Particles>

The procedure of Example 1 was repeated except that methymethacrylate used in Examples 1 was replaced with styrene, to prepare an emulsion composition in which the cationic organic particles are dispersed in water. The emulsion composition had an un-volatile content of 30%, a pH of 6, an average particle diameter, as determined by light scattering measurement, of 95 nm, a particle diameter distribution Dw/Dn of 1.12 and a glass transition temperature as determined from a DSC curve based on JIS K 7121 of 83° C.

<Preparation of Recording Sheet>

The procedure of Example 1 was repeated to prepare a recording sheet of Example 1. The recording sheet had a gloss of 85.

### Comparative Example 1

<Preparation of Cationic Organic Particles>

In Comparative Example 1, 195.9 parts of de-ionized water and 0.1 part of stearyl trimethyl ammonium chloride were fed to a reactor and heated to 70° C. in a nitrogen stream, and then 2 parts of 2,2′-azobis(2-amidinopropan)dichlorinate was added. On the side, 85.0 parts of styrene, 10.0 parts of N-butyl acrylate and 5.0 parts of 2-hydroxyethyl methacrylate were emulsified in 40.0 parts of de-ionized water using 0.3 part of strearyl trimethyl ammonium chloride to prepare an emulsified mixture. Then the emulsified mixture was dropped to the reactor over 4 hr, and kept at the same temperature for 4 hr.

In result, an emulsion composition in which the cationic organic particles are dispersed in water was prepared and had an un-volatile content of 30%, a pH of 5, an average particle diameter, as determined by light scattering measurement, of 90 nm, a particle diameter distribution Dw/Dn of 1.04 and a glass transition temperature as determined from a DSC curve based on JIS K 7121 of 84° C.

<Preparation of Recording Sheet>

The procedure of Example 1 was repeated to prepare a recording sheet. The recording sheet had a gloss of 80.

### Comparative Example 2

In Comparative Example 2, 100 parts of fine particle silica and 20 parts of completely saponified polyvinyl alcohol were added to water and mixed with stirring to prepare a coating composition having a solid content of 15%. The coating composition was applied in an amount such that the absolutely dried coating amount was 20 g/m²on a fine finished paper having a weighing of 105 g/m², and then dried at 50° C. for 100 sec. Subsequently, the resulting recording sheet was passed through a mirror roll which surface was kept at 75° C. while pressure contacting at a linear pressure of 100 Kg/cm. In result, a recording sheet of Comparative Example 2 was prepared and had a gloss of 23.

### Comparative Example 3

In Comparative Example 3, 100 parts of the emulsion composition in which cationic organic particles are dispersed in water prepared in Comparative Example 1 was mixed with 2 parts of T359 (a dispersion of a benzotriazole type ultraviolet light absorbing agent: active principle 30% (manufactured by Asahi Denka Co. Ltd.)) and 1.2 parts of T439 (a dispersion of a hindered amine type light stabilizer: active principle 50% (manufactured by Asahi Denka Co. Ltd.)) to prepare a coating composition. The coating composition was applied in an amount such that the absolutely dried coating amount was 20 g/m² on a fine finished paper having a weighing of 105 g/m², and then dried at 50° C. for 100 sec. Subsequently, the resulting recording sheet was passed through a mirror roll which surface was kept at 75° C. while pressure contacting at a linear pressure of 100 Kg/cm. In result, a recording sheet of Comparative Example 3 was prepared and had a gloss of 75.

### Comparative Example 4

In Comparative Example 4, 100 parts of fine particle silica and 20 parts of completely sapofinied polyvinyl alcohol were added to water and mixed with stirring. To the mixture, 170 parts of the emulsion composition in which the cationic organic particles are dispersed in water prepared in Comparative Example 1 was added to prepare a coating composition. The coating composition was applied in an amount such that the absolutely dried coating amount was 20 g/m² on a fine finished paper having a weighing of 105 g/m², and then dried at 50° C. for 100 sec. Subsequently, the resulting recording sheet was passed through a mirror roll which surface was kept at 75° C. while pressure contacting at a linear pressure of 100 Kg/cm. In result, a recording sheet of Comparative Example 4 was prepared and had a gloss of 43.

### Comparative Example 5

In Comparative Example 5, for preparing a coating composition, 100 parts of the emulsion composition in which the cationic organic particles are dispersed in water prepared in Comparative Example 1 was mixed with 2.3 parts of Sanduvor 3225 Disp (a dispersion of a benzotriazole type ultraviolet light absorbing agent and a hindered amine type light stabilizer: active principle 26.5% (manufactured by Clariant Japan Co. Ltd)). However, the resulting coating composition was aggregated and thereby coating could not be carried out. Therefore, a recording sheet could not be prepared.

[Evaluation Method]

The results of quality evaluation on the recording sheets prepared in the above examples and comparative examples are shown in Table 1.

The evaluations were carried out in the following manners.

<Method of Measuring Particle Diameter>

The average particle diameter and the particle diameter -distribution (Dw/Dn) were measured using a laser particle diameter analyse system LPA-3000/3100 (manufactured by OTSUKA ELECTRONICS CO., LTD).

<Method of Measuring Color Development Concentration>

Using a commercially available ink jet printer (PM800C manufactured by SEIKO EPSON CO., LTD), solid printing with black ink was carried out and the optical reflection concentration in the solid part was measured by a Macbeth densitometer (RD-918).

<Method of Measuring Ink Absorption Characteristics>

Using a commercially available ink jet printer (PM800C manufactured by SEIKO EPSON CO., LTD), yellow ink, magenta ink, cyanic ink and black ink were solid printed in the longitudinal direction and the upper part of the printed sheet just delivered from the printer was pressed to a PPC paper. The degree of transferring the ink to the PPC paper was evaluated with eyes. The evaluation standard was as follows.

O: No ink transfer was observed and the sheet had excellent ink absorption characteristics.

Δ: Ink transfer was slightly observed but the ink absorption characteristics of the sheet were in a practical level.

×: Ink transfer was largely observed and the ink absorption characteristics of the sheet were lower than the practical level.

<Method of Measuring Water Resistance>

Using a commercially available ink jet printer (PM800C manufactured by SEIKO EPSON CO., LTD), character printing was carried out with black ink, and the printed sheet was immersed in city water at 30° C. for 2 min and then evaluated. The printed condition after the immersion such as ooziness, etc was determined with eyes. The evaluation standard was as follows.

O: Almost neither ooziness nor color development concentration change was observed.

Δ: Ooziness or a lowering of the color development concentration was slightly observed but these properties of the sheet were in a practical level.

×: Ooziness or a lowering of the color development concentration was observed and these properties of the sheet were lower than the practical level.

<Method of Measuring Light Resistance>

Using a commercially available ink jet printer (PM800C manufactured by SEIKO EPSON CO., LTD), solid printing was carried out with magenta ink. The printed recording sheet was irradiated with light for 100 hr using a xenon fade meter. The remaining ratio determined by the ratio of the optical reflection concentration after the light irradiation to that before the light irradiation was taken as light resistance.

<Method of Measuring Yellowing Resistance>

A recording sheet before printing was kept at 80° C., at a humidity of 50% for 1 week, and then a color difference between before and after the storage was determined. The color difference (ΔE) was determined-by measuring the colors before and after the light irradiation in accordance with L*a*b* (display method with CIE) and calculating from the formula ΔE={(ΔL*)²+(Δa*)²+(Δb*)²}^{1/2} on the basis of the results. The larger color difference shows causing color deterioration.

<Method of Measuring Glossiness>

In the measurement of glossiness, the glossiness of the recording sheet surface was measured at 75° C. using a varied angle gloss meter (GM-3D model manufactured by MURAKAMI COLOR RESEARCH LABORATORY) on the basis of JIS Z 8741. The larger glossiness shows higher glossiness.

TABLE

| | | Color | | | |
|---|---|---|---|---|---|
| | Ink | development | Water | Light | Yellowing |
| | absorbing | concentra- | resist- | resist- | resist- |
| | characteristics | tion | ance | ance | ance |
| Ex 1 | ∘ | 2.30 | ∘ | 95.1 | 0.9 |
| Ex 2 | ∘ | 2.34 | ∘ | 93.2 | 1.0 |
| Compa. | ∘ | 2.25 | ∘ | 83.9 | 1.2 |
| Ex 1 | | | | | |
| Compa. | Δ | 1.80 | x | 69.3 | 3.4 |
| Ex 2 | | | | | |
| Compa. | ∘ | 2.20 | ∘ | 79.5 | 3.8 |
| Ex 3 | | | | | |
| Compa. | Δ | 1.95 | Δ | 73.5 | 3.0 |
| Ex. 4 | | | | | |

| | |
|---|---|
| Compa. | A recording sheet was not obtained so that |
| Ex. 5 | evaluation could not be conducted. |

1. An ink jet recording medium comprising a support and, on the support, at least one layer comprising cationic organic particles which have a glass transition temperature of from 70 to 130° C. and comprise:
(A) 0.1 to 10% by weight of a monomer having a hindered amine type functional group,
(B) 0.1 to 10% by weight of a monomer having a benzotriazole type functional group and
(C) 80 to 99.8% by weight of a monomer selected from styrene and acrylic monomers.

2. The ink jet recording medium according to claim 1 wherein the cationic organic particles have an average particle diameter of from 10 to 500 nm.

3. The ink jet recording medium according to claim 2 wherein the cationic organic particles have a particle diameter distribution such that a ratio of weight average particle diameter Dw to number average particle diameter Dn (Dw/Dn) is from 1.0 to 2.0.

4. The ink jet recording medium according to ace claim 3 wherein the cationic organic particles have a weight average molecular weight of not less than 10000.

5. The ink jet recording medium according to claim 4 wherein the hindered amine type functional group-having monomer (A) is selected from 1,2,2,6,6-pentamethyl-4-piperidyl methacrylate, 2,2,6,6-tetramethyl-4-piperidyl methacrylate, 1,2,2,6,6-pentamethyl-4-piperidyl acrylate and 2,2,6,6-tetramethyl-4-piperidyl acrylate.

6. The ink jet recording medium according to claim 5 wherein the benzotriazole type functional group having monomer (B) is 2-(2′-hydroxy-5′-methacryloyl oxy ethyl phenyl)-2H-benzotriazole.

7. The ink jet recording medium according to any claim 6 wherein the cationic organic particles are prepared by using an initiator containing an amidino group.

8. The ink jet recording medium according to claim 7 wherein the layer formed from the cationic organic particles are free from inorganic particles.

9. The ink jet recording medium according to any claim 8 wherein the support is made of a paper or a plastic sheet.

10. A process for producing an ink jet recording medium which process comprises:
applying a suspension of copolymeric particles which have a glass transition temperature of from 70 to 130° C. and comprise (A) 0.1 to 10% by weight of a monomer having a hindered amine type functional group, (B) 0.1 to 10% by weight of a monomer having a benzotriazole type functional group and (C) 80 to 99.8% by weight of a monomer selected from styrene and acrylic monomers, on a support, and
allowing the coating surface in a wet state or in a dried state to pressure contact with a mirror roll to smooth the surface.

11. The ink jet recording medium according to claim 1 wherein the cationic organic particles have a particle diameter distribution such that a ratio of weight average particle diameter Dw to number average particle diameter Dn (Dw/Dn) is from 1.0 to 2.0.

12. The ink jet recording medium according to claim 1 wherein the cationic organic particles have a weight average molecular weight of not less than 10000.

13. The ink jet recording medium according to claim 1 wherein the hindered amine type functional group-having monomer (A) is selected from 1,2,2,6,6-pentamethyl-4-piperidyl methacrylate, 2,2,6,6-tetramethyl-4-piperidyl methacrylate, 1,2,2,6,6-pentamethyl-4-piperidyl acrylate and 2,2,6,6-tetramethyl-4-piperidyl acrylate.

14. The ink jet recording medium according to claim 1 wherein the benzotriazole type functional group having monomer (B) is 2-(2′-hydroxy-5′-methacryloyl oxy ethyl phenyl)-2H-benzotriazole.

15. The ink jet recording medium according to claim 1 wherein the cationic organic particles are prepared by using an initiator containing an amidino group.

16. The ink jet recording medium according to claim 1 wherein the layer formed from the cationic organic particles are free from inorganic particles.

17. The ink jet recording medium according to claim 1 wherein the support is made of a paper or a plastic sheet.
